(19) United States
(12) Patent Application Publication
(10) Pub. No.: US 2010/0068334 A1
(43) Pub. Date: Mar. 18, 2010

(54) Medicinal Food and Beverage Compositions and Related Methods for Managing Acne in Humans

(76) Inventor: Damon Randolph Race, Holly Springs, NC (US)

Correspondence Address: Law Offices of Bentley J. Olive, PLLC, 130 Edinburgh Dive South,, Suite 107, Cary, NC, 27511, US

(21) Appl. No.: 12/209,671

(22) Filed: Sep. 12, 2008

(51) Int. Cl. A23L 1/20; A23L 1/09; A23L 1/10; A23L 1/28; A23L 1/29; A23L 1/30; A23L 1/302; A23L 1/304; A23L 2/00; A23D 9/00; A23C 9/20

(52) U.S. Cl. 426/2; 426/104; 426/632; 426/583; 426/72; 426/74; 426/656; 426/601; 426/658; 426/661; 426/662; 426/618; 426/633; 426/580; 426/590; 426/655

(57) ABSTRACT

Medicinal food and beverage compositions and related methods for managing acne in humans are disclosed. A medicinal food composition comprises a mixture of vitamins, minerals, proteins, fats, and pharmacologically active ingredients formulated to manage acne in humans. The mixture can be between about 35-75% by weight of the medicinal food composition. Further, in the mixture, carbohydrates can be about 5-25% by weight of the food composition, fats can be about 8-20% by weight of the food composition, and pharmacologically active ingredients can be about 0.005-25% by weight of the food composition. The medicinal food and beverage compositions may be in the form of nutritional bars, snack cakes, chips, shakes, beverage mixes or beverages.

### TECHNICAL FIELD

The subject matter described herein generally relates to the treatment of skin conditions in humans. In particular, the subject matter described herein relates to medicinal food and beverage compositions and related methods for treating acne in humans.

### BACKGROUND

Acne is the result of a complex interaction of bacteria with the environmental factors found in human skin. It is known that acne can be managed with pharmacologically active compounds such as antibiotics, astringents, retinoids, herbal supplements, and cleansers. While many of these methods of treating acne are somewhat effective, they can cause undesired side effects and many of the topical solutions may even exacerbate the patient's condition.

Of particular interest is the role of diet in the etiology of acne. It has been noted by anthropologists that acne is conspicuously absent in cultures whose diets consist of high protein, unrefined sugars, low glycemic starches, and unrefined oils. Clinical research has confirmed the link between refined sugars, refined oils, and high glycemic starches common in modern diets as being an underlying cause of acne.

Modification of diet for those suffering from acne is extremely difficult given the prevalence of refined sugars, refined oils, and high glycemic starches in modern dietary staples. There exists, therefore, a need in the art for medicinal food and beverage compositions which allow patients to facilitate dietary changes and incorporate pharmacological actives, which used in conjunction are essential to successful management of the disease state. Furthermore, there is a need in the art to combine the pharmacological actives and the appropriate diet into food or beverage compositions or recommended combinations thereof into a customized dietary regimen that offers the patient a convenient method of dietary compliance and dosing of the pharmacological actives.

### SUMMARY

It is an object of the present invention to provide medicinal food and beverage compositions and related methods for managing acne in humans.

An object of the presently disclosed subject matter having been stated hereinabove, and which is achieved in whole or in part by the presently disclosed subject matter. Other objects will become evident as the description described hereinbelow proceeds.

### DETAILED DESCRIPTION

Medicinal food and beverage compositions and related methods for managing acne in humans are disclosed. According to one aspect, a medicinal food composition comprises a mixture of vitamins, minerals, proteins, fats, and pharmacologically active ingredients formulated to manage acne in humans. The mixture can be about 35-75% by weight of the medicinal food composition. Further, in the mixture, carbohydrates can be about 5-25% by weight of the food composition, fats can be about 8-20% by weight of the food composition, and pharmacologically active ingredients can be about 0.005-25% by weight of the food composition. The medicinal food and beverage compositions may be in the form of nutritional bars, snack cakes, chips, shakes, beverage mixes, or beverages.

A medicinal beverage composition for managing acne in humans in accordance with the subject matter described herein can include a mixture of water, milk, vitamins, minerals, proteins, fats, and pharmacologically active ingredients formulated. The mixture can be about 35-85% by weight of the medicinal beverage composition. Further, in the mixture, carbohydrates can be about 5-25% by weight of the beverage composition, fats can be about 8-20% by weight of the beverage composition, and pharmacologically active ingredients can be about 0.005-25% by weight of the beverage composition.

In an example of a medicinal beverage composition, pharmacologically active ingredients of the compositions described herein can include one or more of prescription ingredients, herbal compounds, derivatives or extracts, vitamins, minerals and combinations thereof that are formulated to treat acne in humans.

In another example of a medicinal beverage composition, carbohydrates of the compositions described herein can include one or more of unrefined sugars and low glycemic starches. The fats can include one or more of unrefined oils and natural ingredients containing fats. The medicinal beverage composition can include a mixture of ingredients by weight of about 0-90% milk, 0-95% water, about 0-15% honey, about 0-15% fructose, about 0-5% cane juice, about 0-3% sucralose, about 0-20% isolated soy protein, about 0-15% complete milk protein, about 0-10 % whey protein isolate, about 0-4% flax seed oil, about 0-5% canola oil, about 0-0.3% lecithin, about 0-3% cellulose gel, about 0-3% gum Arabic, about 0-3% carraeenanm, about 0-3% flavoring, about 0.05-5% vitamin and mineral mixture or pharmacological actives.

As referred to herein, the term “medicinal” refers to inclusion beneficial ingredients or exclusion of harmful ingredients in the food and beverage compositions to achieve the intended goals of dietary change and treating, managing, improving or mitigating the disease state.

As referred to herein, the term “food” refers to any solid or liquid material containing nutrients such as carbohydrates, proteins, and fats which are required by humans in order to obtain energy and grow.

As referred to herein, the term “beverage” refers to any liquid material containing water as a constituent which provides humans with the hydration necessary for normal metabolism.

As referred to herein, the term “pharmacological active” refers to prescription ingredients, herbal compounds, derivatives or extracts, vitamins, minerals or combinations of these classes of pharmacologically active ingredients for the intended purpose managing a disease state in humans.

The subject matter described herein provides for medicinal food and beverage compositions which contain proteins, vitamins, minerals, carbohydrates, both simple and complex (grains), a blend of soluble and insoluble dietary fibers, fats and pharmacological actives which are known to have a role in the management of acne, with the added and essential benefit of facilitating dietary change to manage or improve the disease state. The combination of the constituent food parts of the medicinal food and beverage compositions yield the effect of reducing acne in human subjects, where the constituent parts could not singly be incorporated into a dietary regimen or reduce acne. For example, the products are formulated to include low glycemic sources of carbohydrates to avoid pronounced spikes and drops in glucose levels which have been linked to the exacerbation of acne. The products also contains levels of fiber and protein which help lower the glycemic level, and fat at levels which further blunt any sharp rises in glucose levels and promote satiety, which is useful in encouraging dietary avoidance of foods which might exacerbate the disease state.

The protein content of the medicinal food or beverage compositions may come from one or more sources and, based on the weight, can be about 5-25% by weight. Carbohydrates from sources including dietary fiber and unrefined sugars can constitute about 25-85% by weight. Fat should constitute from about 8-20% by weight. The vitamins and minerals include all of the B vitamins needed for energy metabolism. The vitamins and minerals may not add significantly to the total weight of the medicinal food.

The medicinal food and beverage compositions provide nutritional balance having a caloric balance of about 5-25% from protein, about 45-85% from carbohydrate and/or sugar and about 16-40% from fat, the total adding to 100% of the calories. The medicinal food has from about 100-300 calories, preferably from about 150-250 calories. A serving is one or more medicinal food or beverage compositions having a total weight of approximately 45-55 g. The medicinal food and beverage compositions may be used singly or in combination to provide a full serving, which further enhances the patient's ability to customize their dietary regimen.

Protein may be sourced from but not limited to soy, wheat, corn, pea, egg, and milk (whey, casein and caseinate) protein; gelatin, and nuts such as peanuts, almonds and soynuts. The protein may be added as an ingredient per se, such as, for example, a whey protein isolate, or may be sourced from other ingredients such as from example, peanut pieces, or may be a mixture of both.

As referred to herein, the term “carbohydrate” can include simple (mono and disaccharides) and complex (polysaccharides) carbohydrates. Simple carbohydrates are selected from but not limited to evaporated cane juice, malt extract, rice syrup, sucrose, fructose, maltodextrin, lactose, glucose, dextrose and maltose. Simple carbohydrates can be incorporated using natural, minimally processed sources such as but not limited to raisins, date paste, apple paste. Complex carbohydrates can be provided by, but not limited to, sources as cereal grains such as flax seed, wheat, oat, corn, barley, rice, rye, sorghum; legumes both mature and dry, such as soybeans; and nuts such as peanuts, and the like. Cereal grains may also act as sources of fiber, may be rolled, toasted, extruded, gelled and otherwise treated to add to the chew or beverage texture.

In one embodiment, the carbohydrates comprise one or more of unrefined sugars and low glycemic starches. The fats comprise one or more of unrefined oils and natural ingredients containing fats. In addition, the medicinal food composition comprises a mixture of ingredients by weight of about 0-3% organic rice syrup, about 0-15% honey, about 0-5% evaporated cane juice, about 0-3% whey, about 0-4% flax seed oil, about 0-0.3% lecithin, about 0-6% glycerin, about 2-10% rolled oats, about 1.5-8% corn bran, about 4-10% whey protein isolate, about 2-8% evaporated cane juice, about 0-3% flavoring, about 0.05-5% vitamin and mineral mixture, about 0.05-25% pharmacological actives, about 10-25% date paste, and about 5-20% peanuts.

The carbohydrates can be in the form of grains, flakes, flours and meals. Simple carbohydrates including fructose should constitute from about 5-40% of the carbohydrates. Complex carbohydrates should constitute from about 40-70% of the carbohydrates. The blend of carbohydrates including fibers is selected to promote satiety and minimize spikes in glucose levels, while maximizing the flavor of the medicinal food and beverage compositions.

Dietary fiber can be divided into two broad categories: insoluble dietary fiber and water soluble dietary fiber. Examples of dietary fiber include cereal brans and mixtures thereof due to their relatively high insoluble dietary fiber content. Those cereal brans can be selected from the group consisting of rice, wheat, corn, barley, rye, oats, flax seed, pea and mixtures thereof. Wheat, oat and corn bran are the most preferred. The components of the insoluble dietary fiber derived from these cereal brans are known to be cellulose, cellulose gel, cellulose gum, hemicellulose and lignin.

The soluble dietary fibers may be film-forming hydrocolloid materials such as alginates, gums, pectin, mucillages and similar plant exudates. Examples of useful soluble fibers are oat fiber, inulin, oat bran, milled flaxseed, arabic, tragacanth, karaya, ghatti, seaweed extracts including agar, alginates, carrageenans, and furcellan; pectin; and mucellages such as psyllium. Dietary fiber should constitute about 2-15% of the carbohydrates. The ratio of insoluble to soluble fiber can range from 50:50 to about 99:1 with ratios in the range of about 80:20 to about 99:1 preferred. The blend of higher insoluble to soluble also adds to the improved taste characteristics of the medicinal food compositions.

Fat used in the medicinal food compositions of the subject matter described herein can include one or more sources of fat, including but not limited to, dairy sources such as butter, butter oil, milk, dried milk/cream powder and vegetable sources such as coconut, palm kernel, palm, cottonseed, canola, flaxseed, rapeseed, corn, soybean, soy butter, sesame seed, safflower, and olive oils. Fat can be short, medium or long chain triglycerides.

Vitamins and minerals used in the medicinal food compositions of the subject matter described herein may be coated or uncoated. Vitamins include A, B-complex (B1 (thiamine), B2 (riboflavin), B5 (calcium pentothenate), niacin, B6, B12), C, D, E, K, folic acid, biotin, and the like. Minerals and trace elements can include iron, magnesium, phosphorous, potassium, calcium, iodine, zinc, copper, manganese, chromium, selenium, molybdenum, and the like.

In addition to the above nutritional components, the medicinal food or beverage compositions described herein may contain other food or beverage product ingredients such as emulsifiers, flavorants, non-caloric sweeteners, and the like.

Emulsifers may be added for stability of the product. Emulsifiers include lecithin, polyglycerol esters, sorbitan, fatty acid esters, mono- and di-glycerides, and the like.

Flavorants can be used in both the medicinal food and beverage compositions described herein. Flavorants are used in the form of synthetic flavor oils and flavoring aromatics, and/or oils, oleo resins and extracts derived from plants, leaves, flowers, fruits and so forth, and combinations thereof. Non-limiting representative flavor agents include flavor oils such as spearmint, cinnamon, oil of wintergreen (methyl salicylate), peppermint (menthol), clove, bay, anise, eucalyptus, thyme, cedar leaf, oil of nutmeg, allspice, oil of sage, mace, oil of bitter almonds, and cassia oil; artificial, natural and synthetic fruit flavors such as vanilla; citrus oils including lemon, orange, lime, grapefruit; and fruit essences including apple, pear, peach, banana, grape, strawberry, raspberry, cherry, plum, pineapple, apricot and so forth; chocolate flavorings, peanut butter flavoring, rum, butterscotch, toffee, cocoa, coconut, carob, honey, pecan, pistachio, almond, butter, yogurt, molasses powder and the like. Generally any flavoring or food additive, such as those described in Chemicals Used in Food Processing, publication 1274, pages 63-258, by the National Academy of Sciences, may be used.

The medicinal food or beverage compositions described herein may include pharmacologically active compounds known to have a role in the treatment of acne. Pharmacological actives may be incorporated from a variety of sources not limited to prescription ingredients, herbal compounds, derivatives or extracts, vitamins, minerals or combinations of these classes of pharmacologically active ingredients for the intended purpose managing acne in humans.

The medicinal food or beverage compositions may include non-caloric sweeteners such as cyclamates, aspartame, acesulfame-K, and the like; and humectants such as glycerin, sorbitol, xylitol, fructose, dextrose, propylene glycol and other polyols. Other common ingredients such as colorants, preservatives/antioxidants, may be added. The amount of ingredients incidental to the acne management and dietary change objects of the medicinal food and beverage compositions may vary depending on the formulation, end use and consumer preferences.

The following table provides general exemplary use ranges for ingredients which can be used in the practice of the subject matter described herein to provide the desired nutritional blend. Percent weight is by weight of the medicinal food compositions.

TABLE 1
Exemplary Ingredient Use Ranges

| Ingredient | Percent Weight Range |
|---|---|
| Core | 60-90 |
| Binder* | 15-40 |
| Other Ingredients | 40-80 |
| Cereal Grains** | 10-40 |
| Bran (fiber) | 1-10 |
| Fructose | 2-8 |
| Protein | 4-20 |
| Vitamin/Mineral Mix | 0.05-5 |
| Pharmacological Actives | 0.05-25 |
| Flavoring | 0.0-3 |
| Textured Additives | 0.0-30 |
| Coating**** | 10-40 |

*unrefined sugars, flaxseed oil, humectants and emulsifier
**including the rice crisps
*** added as such
****contains 25-40% fat

The medicinal food compositions described herein can be manufactured by techniques used for nutritional bars and snack cakes. An exemplary technique can comprise combining a mixture of the food composition described herein. For example, a technique can include mixing dry ingredients, separately preparing the binder blend (syrup slurry), adding the binder to the dry blend with mixing, heating as necessary to blend the materials, then adding sensitive materials such as flavorants and pharmacological actives. The medicinal food compositions may be formed by conventional techniques including extrusion and sheet forming techniques. In an extrusion technique, the ingredients are transferred to a conventional confectionery bar extruder having roller bars which force the mixture through a die to form the core which can be cut into appropriate size. In a sheet technique, the mixed ingredients can be formed into sheets through roller presses, cut into ribbons subsequently cut into the appropriate size bar core. Any topping layers are applied to the core prior to coating. The bar core can be cooled if necessary and may be coated (enrobed) with a chocolate, yogurt or compound coating.

Dietary modification to address the underlying dietary causes of acne in accordance with the subject matter described herein can be achieved by replacing one or more meals, snacks or beverages a week with the medicinal food or beverage compositions described herein, which are specifically designed to treat the condition. To optimize the efficacy of dietary change and ensure compliance with the dietary regimen, an individual can create a customized dietary regimen that incorporates the medicinal food and beverage compositions.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A medicinal food composition for managing acne in humans, wherein the medicinal food composition comprises a mixture of vitamins, minerals, proteins, fats, and pharmacologically active ingredients formulated to manage acne in humans, wherein the mixture is about 35-75% by weight of the medicinal food composition, carbohydrates are about 5-25% by weight of the food composition, fats are about 8-20% by weight of the food composition, and pharmacologically active ingredients are about 0.005-25% by weight of the food composition.

2. The medicinal food composition of claim 1, wherein the pharmacologically active ingredients comprise at least one of prescription ingredients, herbal compounds, derivatives or extracts, vitamins, minerals and combinations thereof that are formulated to treat acne in humans.

3. The medicinal food composition of claim 1, wherein the carbohydrates comprise at least one of unrefined sugars and low glycemic starches, the fats comprise at least one of unrefined oils and natural ingredients containing fats, and wherein the medicinal food composition comprises a mixture of ingredients by weight of about 0-3% organic rice syrup, about 0-15% honey, about 0-5% evaporated cane juice, about 0-3% whey, about 0-4% flax seed oil, about 0-0.3% lecithin, about 0-6% glycerin, about 2-10% rolled oats, about 1.5-8% corn bran, about 4-10% whey protein isolate, about 2-8% evaporated cane juice, about 0-3% flavoring, about 0.05-5% vitamin and mineral mixture, about 0.05-25% pharmacological actives, about 10-25% date paste, and about 5-20% peanuts.

4. The medicinal food composition of claim 1, wherein the mixture comprises protein.

5. The medicinal food composition of claim 4, wherein the protein is between about 5-25% by weight of the food composition.

6. The medicinal food composition of claim 1, wherein the mixture comprises unrefined sugar.

7. The medicinal food composition of claim 6, wherein the carbohydrates and unrefined sugar are between about 45-85% by weight of the food composition.

8. The medicinal food composition of claim 1, wherein the carbohydrates are sourced from dietary fiber.

9. The medicinal food composition of claim 1, wherein the medicinal food composition is formed of one of a nutritional bar, a snack cake, and a plurality of snack chips.

10. A method for preparing a medicinal food composition for managing acne in humans, the method comprising combining a mixture of a medicinal food composition, the mixture of the medicinal food composition comprising vitamins, minerals, proteins, fats, and pharmacologically active ingredients formulated to manage acne in humans, wherein the mixture is about 35-75% by weight of the medicinal food composition, carbohydrates are about 5-25% by weight of the food composition, fats are about 8-20% by weight of the food composition, and pharmacologically active ingredients are about 0.005-5% by weight of the food composition.

11. The method of claim 10, wherein the pharmacologically active ingredients comprise at least one of prescription ingredients, herbal compounds, derivatives or extracts, vitamins, minerals and combinations thereof that are formulated to treat acne in humans.

12. The method of claim 10, wherein the carbohydrates comprise at least one of unrefined sugars and low glycemic starches, the fats comprise at least one of unrefined oils and natural ingredients containing fats, and wherein the medicinal food composition comprises a mixture of ingredients by weight of about 0-3% organic rice syrup, about 0-15% honey, about 0-5% evaporated cane juice, about 0-3% whey, about 0-4% flax seed oil, about 0-0.3% lecithin, about 0-6% glycerin, about 2-10% rolled oats, about 1.5-8% corn bran, about 4-10% whey protein isolate, about 2-8% evaporated cane juice, about 0-3% flavoring, about 0.05-5% vitamin and mineral mixture, about 0.05-25% pharmacological actives, about 10-25% date paste, and about 5-20% peanuts.

13. The method of claim 10, wherein the mixture comprises protein.

14. The method of claim 10, wherein the mixture comprises unrefined sugar.

15. The method of claim 14, wherein the carbohydrates and unrefined sugar are between about 45-85% by weight of the food composition.

16. The method of claim 10, comprising forming the medicinal food composition into one of a nutritional bar, a snack cake, and a plurality of snack chips.

17. The method of claim 10, comprising forming the medicinal food composition into one of a nutritional bar and a snack cake using one of an extrusion technique and a sheet forming technique.

18. A medicinal beverage composition for managing acne in humans, wherein the medicinal beverage composition comprises a mixture of water, milk, vitamins, minerals, proteins, fats, and pharmacologically active ingredients formulated to manage acne in humans, wherein the mixture is about 35-85% by weight of the medicinal beverage composition, carbohydrates are about 5-25% by weight of the beverage composition, fats are about 8-20% by weight of the beverage composition, and pharmacologically active ingredients are about 0.005-25% by weight of the beverage composition.

19. The medicinal beverage composition of claim 18, wherein the pharmacologically active ingredients comprise at least one of prescription ingredients, herbal compounds, derivatives or extracts, vitamins, minerals and combinations thereof formulated to treat acne in humans.

20. The medicinal beverage composition of claim 18, wherein the carbohydrates comprise at least one of unrefined sugars and low glycemic starches, the fats comprise at least one of unrefined oils and natural ingredients containing fats, and wherein the medicinal beverage composition comprises a mixture of ingredients by weight of about 0-90% milk, 0-95% water, about 0-15% honey, about 0-15% fructose, about 0-5% cane juice, about 0-3% sucralose, about 0-20% isolated soy protein, about 0-15% complete milk protein, about 0-10% whey protein isolate, about 0-4% flax seed oil, about 0-5% canola oil, about 0-0.3% lecithin, about 0-3% cellulose gel, about 0-3% gum Arabic, about 0-3% carraeenanm, about 0-3% flavoring, about 0.05-5% vitamin and mineral mixture or pharmacological actives.
